(19) United States
(12) Patent Application Publication
(10) Pub. No.: US 2007/0046809 A1
(43) Pub. Date: Mar. 1, 2007

(54) Image pickup device, multi-eye image pickup device and control program for multi-eye image pickup device

(75) Inventor: Satoshi Nakamura, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/511,304

(22) Filed: Aug. 29, 2006

(30) Foreign Application Priority Data
Aug. 29, 2005 (JP) 2005-248288

(51) Int. Cl. H04N 5/235

(52) U.S. Cl. 348/362

(57) ABSTRACT

A stereoscopic image pickup device comprises first and second imaging units, a communication I/F and a CPU. The communication I/F performs communication with an external control device. The CPU controls the imaging units and the communication I/F. Each of the imaging units comprises a taking lens, a shutter mechanism and a CCD. At normal times, preview-image data is produced on the basis of image signals outputted from the CCDs. The produced preview-image data is transmitted to the external control device via the communication I/F and a communication cable. Upon reception of a control signal outputted from the external control device, preview-image shooting is halted and is changed to regular-image shooting to produce regular-image data. While the regular-image data is transmitted to the external control device, the shutter mechanisms are kept in a closed state.

### FIELD OF THE INVENTION

The present invention relates to an image pickup device and a multi-eye image pickup device for capturing image data from an image sensor and for transferring the image data to an external controller.

### BACKGROUND OF THE INVENTION

In recent years, an image pickup device using a solid-state image sensor rapidly becomes popular. In this kind of the image pickup device, an image is captured as digital data. Since the solid-state image sensor is further downsized and is manufactured at lower cost, a multi-eye image pickup device provided with a plurality of imaging units, which respectively comprise the solid-state image sensor and a taking lens, is put to practical use. Among such multi-eye image pickup devices, a stereoscopic image pickup device for taking a stereoscopic image is known. This kind of the stereoscopic image pickup device comprises a pair of imaging units capable of simultaneously shooting a subject at different angles to obtain the data of two images having parallax. In the stereoscopic image pickup device, it is possible to three-dimensionally analyze the subject, which is taken as the images having the parallax, by means of a so-called stereo method. The stereoscopic image pickup device is recently beginning to be utilized for a biometrics camera, a security camera and so forth. The biometrics camera is used for identifying a contour of a face and so forth. The security camera is used for correctly counting a number of persons entering a supervised area.

When the multi-eye image pickup device is used as the biometrics camera and the security camera, the multi-eye image pickup device is placed at a position where it is possible to shoot a subject. At this time, the multi-eye image pickup device is generally actuated in accordance with control signals outputted from an external controller, which is placed at a remote location separating from the subject. The multi-eye image pickup device used as the biometrics camera and the security camera is described in Japanese Patent Laid-Open Publication No. 2002-190972, for instance. In this kind of the image pickup device, the image sensor is generally used in a condition of prolonged actuation. In this regard, the remote control camera system described in the Publication No. 2002-190972 is provided with a movable barrier disposed in front of a lens unit. At a time of shooting, the movable barrier is kept in an open state to expose the lens unit. At a time of non-shooting, the movable barrier is kept in a closed state to prevent unnecessary light from entering the lens unit.

However, when the image pickup device is controlled from the external controller placed at the remote location, the image sensor built in the image pickup device is kept in the state of prolonged actuation during which the ambient light always enters a light-receiving area of the image sensor. Consequently, the image sensor is likely to deteriorate and a problem of durability arises. Particularly, in the image pickup device constantly sending a preview image at a normal time and performing regular shooting at any timing in response to the control signal of the external controller, pixels are thinned in the preview-image shooting relative to the regular shooting. In other words, the preview-image shooting is performed in an intermittent readout pattern. Due to this, the pixels of the light-receiving area used in the constant shooting are depleted in comparison with the pixels thereof which are not used in the preview shooting. Thus, endurance of the image sensor is shortened.

Meanwhile, it is considered to prevent the unnecessary light from entering the image sensor by providing the movable barrier such as described in the above-noted Publication No. 2002-190972. However, this Publication teaches the control method for the remote control camera system in which the movable barrier is moved to the light shielding position in response to communication performed between the external controller and the remote control camera system. Thus, if the communication is performed, the movable barrier is moved even when the image sensor outputs the image signal. Thus, when the camera is used for the biometrics and the security, there is a possibility that shooting is not performed at important timing if the movable barrier happens to be kept in the light-shielding state.

### SUMMARY OF THE INVENTION

In view of the foregoing, it is a primary object of the present invention to provide an image pickup device in which image data obtained from an image sensor for a prolonged period is transmitted to an external control device and deterioration of the image sensor is retarded to elongate a lifetime thereof.

It is a second object of the present invention to provide a multi-eye image pickup device and a control program for the same in which image data obtained from an image sensor for a prolonged period is transmitted to an external control device and deterioration of the image sensor is retarded to elongate a lifetime thereof.

In order to achieve the above and other objects, the image pickup device according to the present invention comprises an optical system, an image sensor, a signal processor, a communication processor and a controller. The optical system includes a shutter mechanism. The image sensor is disposed behind the optical system. The signal processor processes an image signal outputted from the image sensor. The signal processor produces preview-image data and regular-image data on the basis of the image signal. The communication processor performs transmission and reception with the external control device via a communication tool. The controller controls the communication processor to transmit the preview-image data to the external control device in real time. The controller halts the transmission of the preview-image data and transmits the regular-image data to the external control device upon reception of a control signal which is sent from the external control device to request regular-image shooting. While the regular-image data is transmitted, the shutter mechanism is kept in a closed state to prevent ambient light from entering the image sensor.

The multi-eye image pickup device according to the present invention comprises a plurality of imaging units, a signal processor, a communication processor and a controller. The respective imaging units have an optical system, in which a shutter mechanism is included, and an image sensor disposed behind the optical system. The signal processor processes an image signal outputted from the image sensor. The signal processor produces preview-image data and regular-image data on the basis of the image signal. The communication processor performs transmission and reception with the external control device via a communication tool. The controller controls the communication processor to transmit the preview-image data to the external control device in real time. The controller halts the transmission of the preview-image data and transmits the regular-image data to the external control device upon reception of a control signal which is sent from the external control device to request regular-image shooting. While the regular-image data is transmitted, the shutter mechanism is kept in a closed state to prevent ambient light from entering the image sensor.

The shutter mechanism is changeable between the closed state in that a shutter member prevents the ambient light from entering the image sensor, and an open state in that the shutter member is evacuated and allows the ambient light to enter the image sensor. As to the image sensor, a CCD and a CMOS type are used.

It is preferable that one of the imaging units is selected and the preview-image data is obtained from the image signal outputted from the selected imaging unit. Moreover, it is preferable to use the imaging units such that the imaging unit from which the preview-image data is obtained is changed every predetermined period. Alternatively, it is preferable to use the imaging units such that the imaging unit from which the preview-image data is obtained is changed after transmitting the regular-image data.

The control program according to the present invention makes the multi-eye image pickup device execute the steps of transmitting the preview-image data to the external control device in real time and producing the regular-image data upon reception of the control signal which is sent from the external control device to request regular-image shooting. Moreover, the control program makes the multi-eye image pickup device execute the step of halting the transmission of the preview-image data after producing the regular-image data to transmit the regular-image data to the external control device. Further, the control program makes the multi-eye image pickup device execute the step of keeping the shutter mechanism in the closed state to prevent ambient light from entering the image sensor while the regular-image data is transmitted.

It is preferable to make the multi-eye image pickup device execute the step of selecting one of the imaging units to obtain the preview-image data therefrom. Moreover, it is preferable to make the multi-eye image pickup device execute the step of changing the selected imaging unit every predetermined period. It is also preferable to make the multi-eye image pickup device execute the step of changing the selected imaging unit in association with the transmission of said regular-image data.

According to the present invention, the image data obtained from the image sensor for a prolonged time is transmitted to the external control device and deterioration of the image sensor is retarded to elongate the lifetime thereof.

### BRIEF DESCRIPTION OF THE DRAWINGS

FIG. 1 is a configuration diagram of a stereoscopic image pickup system;

FIG. 2 is a perspective view of a stereoscopic image pickup device;

FIG. 3 is a block diagram showing an electrical structure of the stereoscopic image pickup device according to a first embodiment of the present invention;

FIG. 4 is a block diagram showing an electrical structure of an external controller;

FIG. 5 is a flowchart showing a sequence executed from a request for preview-image commencement until transmission of regular-image data;

FIG. 6 is a flowchart showing a sequence executed after receiving a request for regular-image shooting and before transmitting the regular-image data;

FIG. 7 is an explanatory illustration showing an operational menu picture displayed on the external controller;

FIG. 8 is a flowchart showing a sequence executed from a request for preview-image commencement until transmission of regular-image data in a stereoscopic image pickup system according to a second embodiment of the present invention;

FIG. 9 is a flowchart showing a sequence executed after the stereoscopic image pickup device has received a regular-image shooting request and before the regular-image shooting is performed;

FIG. 10 is a flowchart showing a sequence executed after the stereoscopic image pickup device has received a request for regular-image-data transmission and before the regular-image data is transmitted;

FIG. 11 is an explanatory illustration showing an operational menu picture displayed on the external controller;

FIG. 12 is a flowchart showing a sequence executed for transmitting preview-image data after changing an imaging unit which performs preview shooting in a stereoscopic image pickup system according to a third embodiment of the presents invention;

FIG. 13 is a flowchart showing a sequence in which the stereoscopic image pickup device changes the imaging unit performing preview shooting;

FIG. 14 is an explanatory illustration showing an operational menu picture displayed on the external controller;

FIG. 15 is a flowchart showing a sequence executed for changing regular-image shooting and the imaging unit performing preview-image shooting in a stereoscopic image pickup system according to a fourth embodiment of the present invention;

FIG. 16 is a flowchart showing a sequence in which the stereoscopic image pickup device transmits the regular-image data and changes the imaging unit performing preview-image shooting;

FIG. 17 is an explanatory illustration showing an operational menu picture displayed on the external controller;

FIG. 18 is a block diagram showing an electrical structure of a stereoscopic image pickup device according to a fifth embodiment of the present invention;

FIG. 19 is a flowchart showing a sequence executed for changing the imaging unit performing preview-image shooting in the stereoscopic image pickup system of the fifth embodiment;

FIG. 20 is a flowchart showing a sequence in which the stereoscopic image pickup device changes the imaging unit performing preview-image shooting; and

FIG. 21 is a block diagram showing an electrical structure of a stereoscopic image pickup device of a sixth embodiment of the present invention.

### DESCRIPTION OF THE PREFERRED EMBODIMENTS

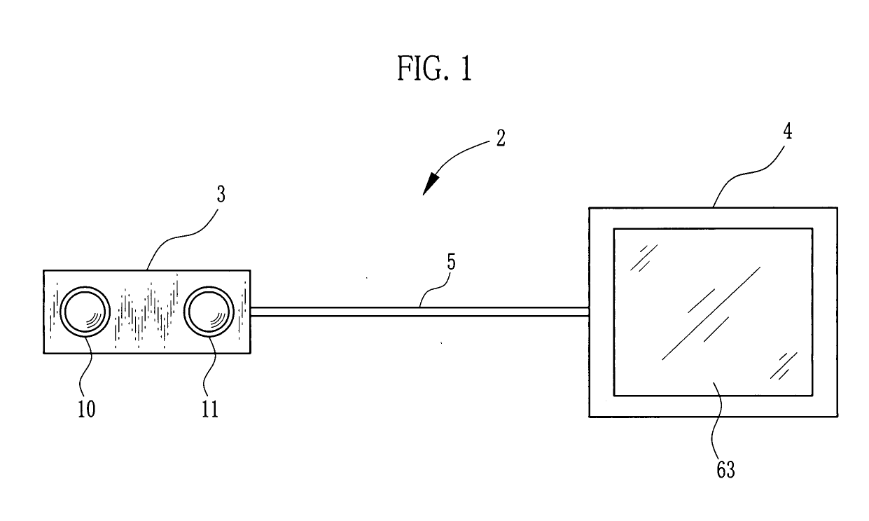

FIG. 1 shows a configuration diagram of a stereoscopic image pickup system 2 according to the present invention. The stereoscopic image pickup system 2 comprises a stereoscopic image pickup device 3, a controller (external control device) 4 for controlling an operation of the stereoscopic image pickup device 3, and a communication cable 5 for connecting these devices. The stereoscopic image pickup device 3 is provided with a first imaging unit 10 and a second imaging unit 11 disposed at a predetermined interval. As to the communication cable 5, USB and IEEE1394 are utilized, for example, to enable intercommunication between the stereoscopic image pickup device 3 and the controller 4. The communication cable 5 supplies electric power (so-called bus power) from the controller 4 to the stereoscopic image pickup device 3.

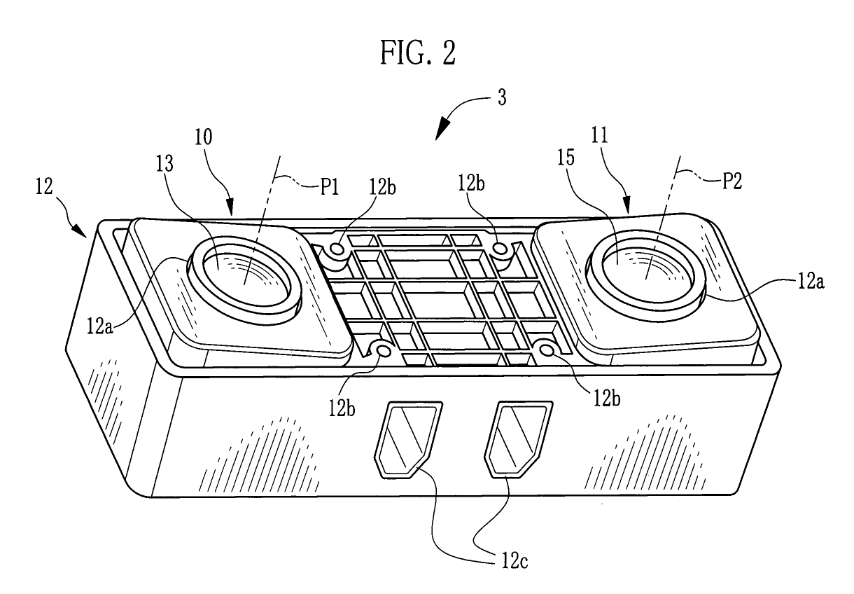

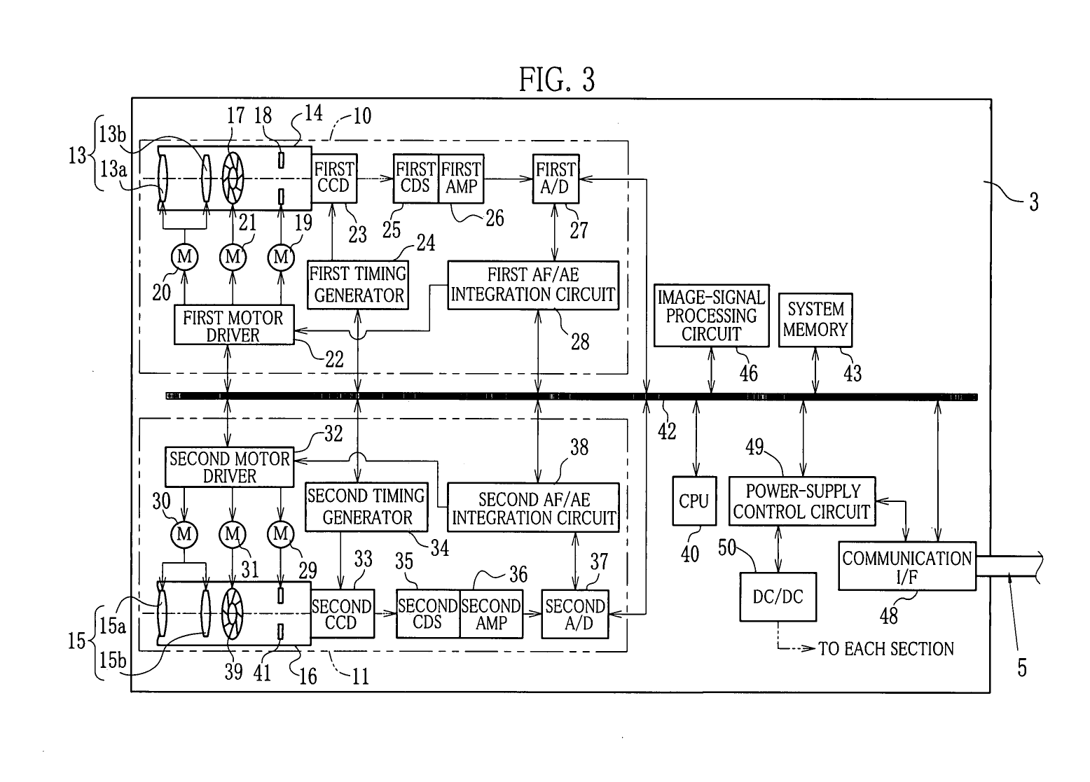

FIG. 2 is a perspective view of the stereoscopic image pickup device 3 composed of the first imaging unit 10, the second imaging unit 11 and a case 12 for holding these units 10 and 11. The first imaging unit 10 includes a first taking lens 13 and a first lens barrel 14 (see FIG. 3) for holding the first taking lens 13. Similarly to the first imaging unit 10, the second imaging unit 11 includes a second taking lens 15 and a second lens barrel 16 (see FIG. 3) for holding the second taking lens 15.

The respective imaging units 10 and 11 are attached to the case 12 in a state that optical axes P1 and P2 of these units 10 and 11 are slightly inclined inward so as to converge. The front of the case 12 is provided with openings 12a formed for exposing the respective imaging units 10 and 11. The front of the case 12 is further provided with screw holes 12b formed for attaching the stereoscopic image pickup device 3 to an exclusive bracket, an exclusive stay, other device and so forth. Further, the side of the case 12 is provided with connectors 12c for connecting with the communication cable 5.

FIG. 3 is a block diagram showing an electrical structure of the stereoscopic image pickup device 3. The first imaging unit 10 is composed of the first lens barrel 14, a first shutter drive motor 19, a first focus motor 20, a first stop drive motor 21, a first motor driver 22, a first CCD (image sensor) 23, a first timing generator 24, a first CDS 25, a first AMP 26, a first A/D converter 27 and a first AF/AE integration circuit 28.

The first lens barrel 14 contains the first taking lens 13, a stop mechanism 17, a shutter mechanism 18 and so forth. The first taking lens 13 comprises a zoom lens 13a and a focus lens 13b. The shutter mechanism 18 is switched between an open state and a closed state by the first shutter drive motor 19. The shutter mechanism 18 is a mechanical type. When the shutter mechanism 18 is kept in the closed state, a shutter plate is positioned at an optical path of the first taking lens 13 to prevent ambient light from entering an imaging area of the first CCD 23. When the shutter mechanism is kept in the open state, the shutter plate is evacuated from the optical path of the first taking lens 13 to allow the ambient light to enter the imaging area of the first CCD 23. In this embodiment, the shutter mechanism 18 is controlled so as to be set to the closed state upon reception of a control signal which is outputted from the controller 4 connected to the stereoscopic image pickup device 3.

The zoom lens 13a and the focus lens 13b are moved in an optical-axis direction by the first focus motor 20. Further, a stop diameter of the stop mechanism 17 is changed by the first stop drive motor 21. All of the first shutter drive motor 19, the first focus motor 20 and the first stop drive motor 21 are connected to the first motor driver 22 connected to a CPU 40, which controls the whole of the stereoscopic image pickup device 3, via a data bus 42. The CPU 40 controls the first motor driver 22 to actuate the first shutter drive motor 19, the first focus motor 20 and the first stop drive motor 21.

The first CCD 23 is disposed behind the first taking lens 13. The first taking lens 13 forms a subject image on a light-receiving surface of the first CCD 23 connected to the first timing generator 24, which is connected to the CPU 40 via the data bus 42. The CPU 40 controls the first timing generator 24 to generate a timing signal (clock pulse). In response to an input of the timing signal, the first CCD 23 is activated to photoelectrically convert the subject image into an electrical signal. This image signal is sent to the first CDS 25 which is a correlation double sampling circuit.

In this embodiment, the first CCD 23 is driven in accordance with either one of two kinds of readout patterns. In other words, the first CCD 23 is driven after setting either one of an all pixel readout pattern and an intermittent readout pattern. In the all pixel readout pattern, signals of all the pixels are read out. In the intermittent readout pattern, the signals of the pixels arranged in a horizontal scanning direction are intermittently read out in a vertical direction in accordance with image resolution. For example, in the intermittent readout pattern, the image signals are alternately thinned in the vertical direction and are read out at a rate of half of scanning lines of the first CCD 23.

The first CDS 25 obtains the image signal from the first CCD 23 and outputs image data of R, G and B correctly corresponding to an accumulated charge amount of each pixel of the first CCD 23. The image data outputted from the first CDS 25 is amplified by the first AMP 26 and is converted into digital data by the first A/D converter 27. The digitized image data is outputted as right-eye image data from the first A/D converter 27 to a system memory 43 via the data bus 42. In addition, the digitized image data is also outputted to the first AF/AE integration circuit 28.

The first AF/AE integration circuit 28 performs an exposure operation and a focal position operation on the basis of the right-eye image data. In this embodiment, when the first AF/AE integration circuit 28 performs the exposure operation, brightness level of the image data outputted from the A/D converter 27 is accumulated by one frame and an accumulated value is outputted to the first motor driver 22 as exposure information.

Meanwhile, when the first AF/AE integration circuit 28 automatically detects a focal position, only high-pass component of the brightness level is extracted from the image signal and is accumulated, for example. And then, an accumulated value is outputted to the first motor driver 22 as a focus evaluation value.

The first motor driver 22 is controlled on the basis of the focus evacuation value and the exposure information, which are sent from the first AF/AE integration circuit 28, to actuate the first focus motor 20. In virtue of this, the focus lens 13b is moved to an optimum position to adjust the focal position. At the same time, the first stop drive motor 21 is actuated to adjust the stop mechanism 17 to an optimum f-number.

The second imaging unit 11 has a similar structure with the first imaging unit 10. The second imaging unit 11 is composed of the second lens barrel 16, a second shutter drive motor 29, a second focus motor 30, a second stop drive motor 31, a second motor driver 32, a second CCD (image sensor) 33, a second timing generator 34, a second CDS 35, a second AMP 36, a second A/D converter 37 and a second AF/AE integration circuit 38. The second lens barrel 16 contains the second taking lens 15, a stop mechanism 39 and a shutter mechanism 41. The second taking lens 15 comprises a zoom lens 15a and a focus lens 15b. Left-eye image data digitally converted by the second A/D converter 37 is outputted to the system memory 43 via the data bus 42 and is also outputted to the second AF/AE integration circuit 38. Similarly to the first CCD 23, the second CCD 33 is activated in either one of the all pixel readout pattern and the intermittent readout pattern. Meanwhile, the shutter mechanism 41 is changed by the second shutter drive motor 29 between an open state and a closed state.

In the second AF/AE integration circuit 38, an exposure operation and a focal position operation are performed on the basis of the left-eye image data. Similarly to the first AF/AE integration circuit 28, the second AF/AE integration circuit 38 derives exposure information and a focus evacuation value to be outputted to the second motor driver 32. On the basis of the focus evacuation value and the exposure information sent from the second AF/AE integration circuit 38, the second motor driver 32 is controlled to actuate the second focus motor 30. In virtue of this, the focus lens 15b is moved to an optimum position to adjust the focus. In addition, the second stop drive motor 31 is actuated to adjust the stop mechanism 39 to an optimum f-number.

The CPU 40 temporarily stores the image data in a predetermined region of the system memory 43 comprising a ROM and a RAM. The system memory 43 stores setting information and various programs for controlling the stereoscopic image pickup device 3. Moreover, the system memory 43 works as a buffer for temporarily storing the program, which is read out by the CPU 40, and the obtained image data.

The CPU 40 is connected to an image-signal processing circuit 46 via the data bus 42. The image-signal processing circuit 46 reads the image data from the system memory 43 and performs various image processes therefor. As to the image processes, are performed gradation conversion, white-balance processing and gamma correction processing, for example. The processed image data is stored in the system memory 43 again.

Further, the CPU 40 is connected to a communication I/F (communication tool) 48 via the data bus 42. The communication I/F 48 is connected to the communication cable 5 via the connector 18 and is formed with a circuit based on specification of the communication cable 5. The CPU 40 performs communication with external equipments including the controller 4, via the communication I/F 48 and the communication cable 5. The communication I/F 48 is also connected to a power-supply control circuit 49 comprising a filter and a limiter. The filter removes power supply noise. The limiter prevents overcurrent. The power-supply control circuit 49 distributes the bus power, which is supplied via the communication cable 5, to the respective sections of the stereoscopic image pickup device 3 through a DC/DC converter 50. The image data stored again in the system memory 43 after performing the various image processes is outputted to the communication I/F 48 and is transmitted to the external equipment via the communication cable 5.

In this embodiment, when the CPU 40 has received a control signal from the controller 4 via the communication I/F 48 and the communication cable 5, the CPU 40 captures regular-image data and transmits this data to the controller 4 via the communication I/F 48 and the communication cable 5. The control signal from the controller 4 is described later in detail.

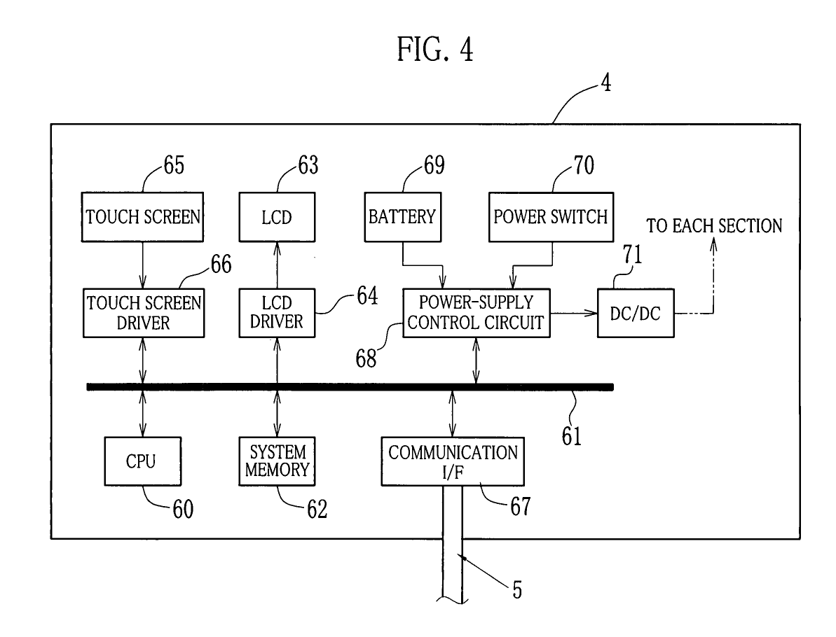

FIG. 4 is a block diagram showing an electrical structure of the controller 4. The respective sections of the controller 4 are integrally controlled by a CPU 60. A system memory 62 connected to the CPU 60 via a data bus 61 includes a ROM and a RAM to store various programs and setting information for operating the controller 4. The system memory 62 also works as a buffer for temporarily storing the program and so forth read by the CPU 60.

A front side of the controller 4 is provided with an LCD panel 63 (see FIG. 1) to display various pictures in accordance with the programs stored in the system memory 62. The LCD panel 63 is connected to the CPU 60 via an LCD driver 64 and the data bus 61 to display various pictures under the control of the CPU 60. In addition, a touch screen 65 is disposed on the LCD panel 63. The touch screen 65 is connected to the CPU 60 via a touch screen driver 66 and the data bus 61 to carry a coordinate of a pressed position to the CPU 60. An icon, a check box and so forth are displayed on the LCD panel 63 by the CPU 60, which detects pressure thereof by means of the touch screen 65 to receive an operational instruction from an operator.

A communication I/F 67 and a power-supply control circuit 68 are connected to the CPU 60 via the data bus 61. The communication I/F 67 is connected to the communication cable 5 via a connector. The CPU 60 performs communication with the stereoscopic image pickup device 3 via the communication I/F 67 and the communication cable 5. The power-supply control circuit 68 comprises a filter for removing power-supply noise, a limiter for preventing overcurrent, and so forth. A battery 69 and a power switch 70 are connected to the power-supply control circuit 68. The power switch 70 is exposed to the outside of the controller 4. In accordance with an ON/OFF state of the power switch 70, an electric power is sent from the battery 69 to a DC/DC converter 71 by which the electric power, which is sent from the power-supply control circuit 68, is converted into a predetermined voltage. The converted electric power is supplied to the respective sections of the controller 4. The electric power from the DC/DC converter 71 is also supplied to the communication I/F 67 and is sent to the stereoscopic image pickup device 3 as the bus power. Incidentally, turning on and off the power supply of the stereoscopic image pickup device 3 is controlled in association with whether the bus power is supplied or not from the external equipments including the controller 4.

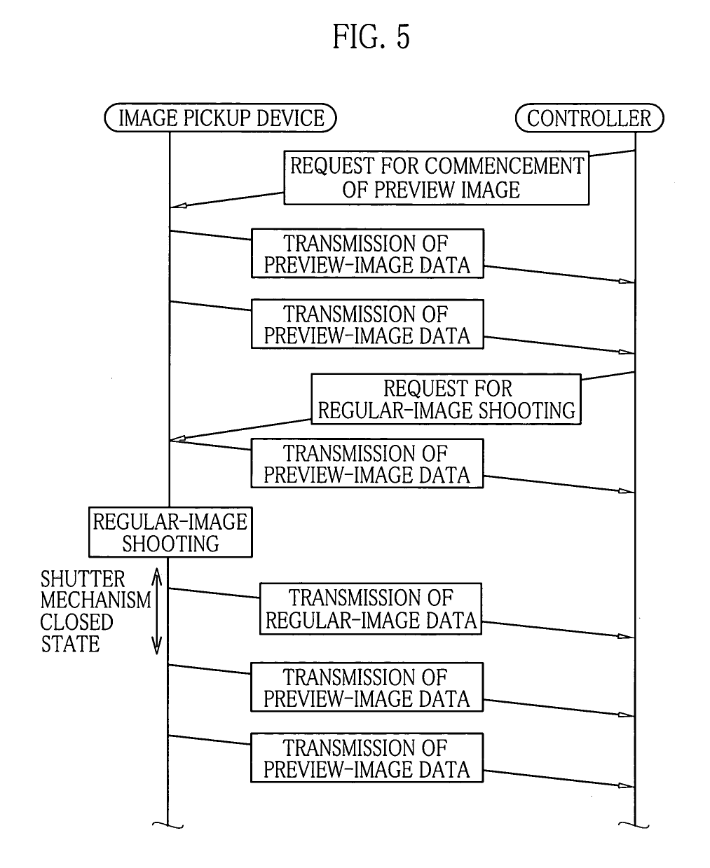

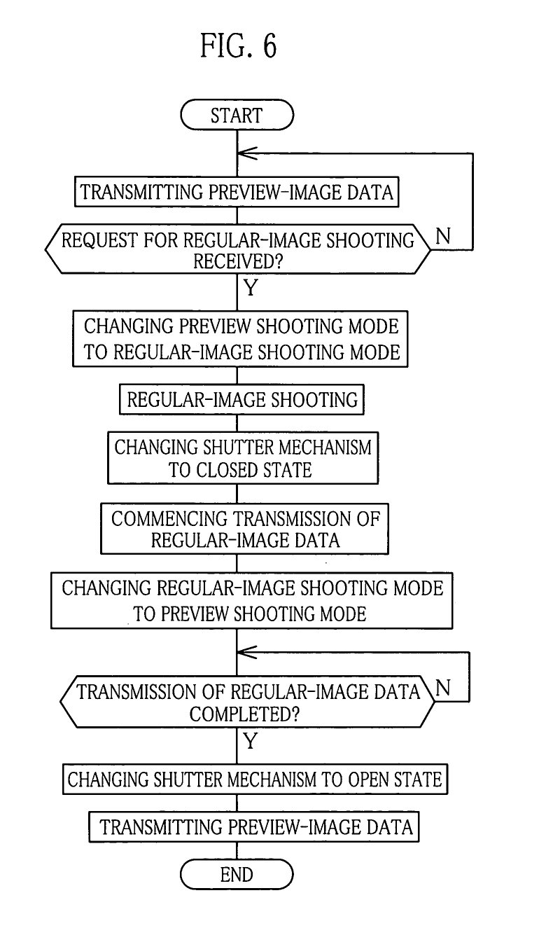

Next, an operation of the stereoscopic image pickup system 2 having the above structure is described below with reference to flowcharts and an operational menu picture shown in FIGS. 5, 6 and 7. First of all, the stereoscopic image pickup device 3 is screwed to the other device by utilizing the screw hole 12b in a case that the image pickup device 3 is used as an authentication camera, for example. Meanwhile, in a case that the image pickup device 3 is used as a security camera, the image pickup device 3 is screwed to an exclusive bracket, an exclusive stay and so forth. After that, the image pickup device 3 is attached to a pillar, a ceiling and so forth.

In using the stereoscopic image pickup device 3, the controller 4 is connected thereto via the communication cable 5 to construct the stereoscopic image pickup system 2, and then the power switch 70 of the controller 4 is turned on. Upon turning on the power switch 70, the electric power of the battery 69 is distributed to the respective sections of the controller 4 via the power-supply control circuit 68 and the DC/DC converter 71. The CPU 60 to which the electric power has been distributed supplies the bus power to the stereoscopic image pickup device 3 via the communication cable 5 to drive the image pickup device.

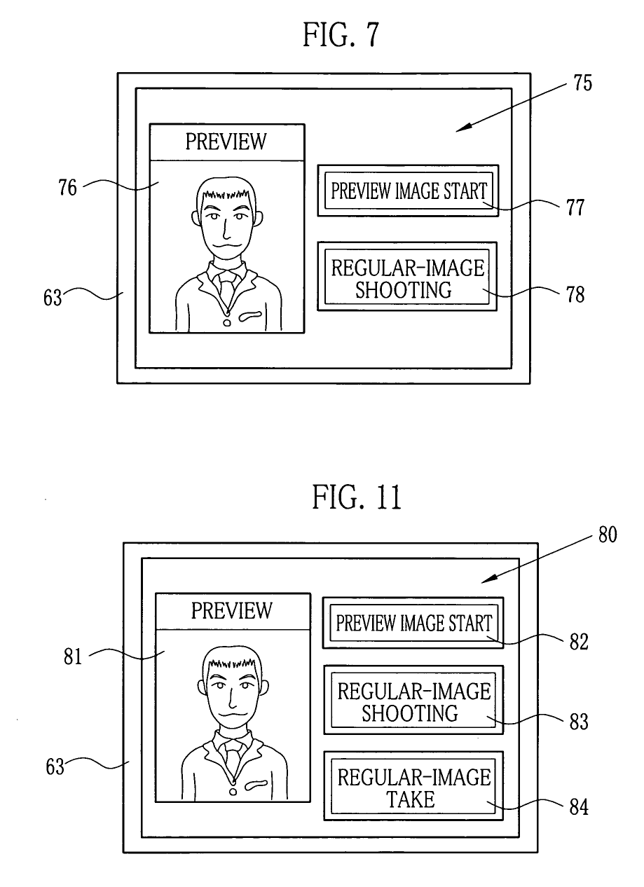

The stereoscopic image pickup device 3 set to the activation state such as described above is used as the security camera, the authentication camera and so forth. The LCD panel 63 of the controller 4 displays an operational menu picture 75 shown in FIG. 7. Within the operational menu picture 75, are arranged an image display area 76 and menu buttons 77 and 78. The image display area 76 displays a preview image and a regular image. The menu button 77 is pressed to request commencement of the preview image. The menu button 78 is pressed to request shooting of the regular image. When a pressed position of the touch screen 65 corresponds to the menu button 77 of the operational menu picture 75, the CPU 60 sends a control signal to the stereoscopic image pickup device 3 to request the commencement of the preview image. The CPU 40 receives the control signal which is forwarded to the image pickup device 3 via the communication I/F 67, the communication cable 5 and the communication I/F 48 to request the commencement of the preview image. Upon receiving the control signal, the CPU 40 activates the respective first and second imaging units 10 and 11 including the first CCD 23 and the second CCD 33 to start outputting the image signal. Incidentally, when the received control signal requests the preview image, the readout pattern of the CCDs 23 and 33 is set to the intermittent readout pattern. The image signal of one frame is read in the intermittent readout pattern and is temporarily stored in the system memory 43. And then, various kinds of signal processing are performed to produce preview-image data. The produced preview-image data is transmitted to the controller 4 via the communication I/F 48, the communication cable 5 and the communication I/F 67. On the basis of the transmitted preview-image data, the preview image is displayed within the image display area 76 of the LCD panel 63. After that, the successive preview image is repeatedly produced in the identical sequence and is transmitted to the controller 4. In this way, the preview image is displayed as a through image.

As described above, the preview-image data is normally transmitted to the controller 4 in real time to display the preview image within the image display area of the LCD panel 63 of the controller 4 as the through image. When a position of the touch screen 65 corresponding to the menu button 78 has been pressed during the display of the preview image, the control signal for requesting regular-image shooting is sent from the controller 4 to the stereoscopic image pickup device 3.

When the CPU 40 has received the control signal requesting the regular-image shooting, the CPU 40 changes the shooting mode of the first and second imaging units 10 and 11 including the CCDs 23 and 33. Further, the CPU 40 activates the respective sections to perform the regular-image shooting and outputs the image signal. Incidentally, upon reception of the control signal requesting the regular-image shooting, the transmission of the preview-image data is halted. And then, the shooting mode of the first and second imaging units 10 and 11 is changed from the preview shooting mode to the regular-image shooting mode. At this time, the readout pattern of the CCDs 23 and 33 is changed from the intermittent readout pattern to the all pixel readout pattern. In the changed readout pattern, the image signal is read by one frame. The read image signal is temporarily stored in the system memory 43. After that, various kinds of signal processing are performed to produce the regular-image data. The produced regular-image data is transmitted to the controller 4 via the communication I/F 48, the communication cable 5 and the communication I/F 67. During the transmittance of the regular-image data, the CPU 40 activates the motor drivers 22 and 32 of the first and second imaging units 10 and 11 to set the first and second shutter mechanisms 18 and 41 to the closed state so that the ambient light is prevented from entering the first CCD 23 and the second CCD 33.

On the basis of the regular-image data received by the controller 4, the regular image is displayed within the image display area 76 of the LCD panel 63. At the same time, the regular-image data is recorded in the system memory 62 of the controller 4. After completing the transmission of the regular-image data, the first and second shutter mechanisms 18 and 41 are returned to the open state. Further, the first and second imaging units 10 and 11 are changed to the preview shooting mode to commence the output of the image signal again. The stereoscopic image pickup device 3 is returned to the normal state in that the preview-image data is transmitted, and the preview image is displayed on the controller 4.

In this way, the shutter mechanisms 18 and 41 are kept in the closed state during the transmission of the regular-image data to prevent the ambient light from entering the first CCD 23 and the second CCD 33. Thus, deterioration of the CCD is retarded so that a lifetime of the stereoscopic image pickup device 3 is elongated. In this embodiment, while the CCD performs shooting, the intermittent readout pattern and the all pixel readout pattern are changed. However, since the ambient light is prevented from entering the CCD as describe above, it is possible to retard the deterioration of the light-receiving area of the CCD.

By the way, in the above embodiment, the stereoscopic image pickup device 3 activates both of the first and second imaging units 10 and 11 to take the regular image upon reception of the control signal requesting the regular-image shooting, and the regular-image data is produced from the outputted image signal. After that, the regular-image data is transmitted to the controller 4. During this period, the transmission of the preview-image data is halted. The present invention, however, is not limited to this. In a second embodiment described below, the transmission of the preview image is halted and the shutter mechanism is kept in the closed state only while the regular-image data is transmitted after producing the regular-image data of the taken regular image. A stereoscopic image pickup system used in the second embodiment has a similar structure with the first embodiment and comprises the stereoscopic image pickup device 3, the controller 4 and the cable 5 for connecting these devices.

In this embodiment, there are two control signals to be sent form the controller 4 to the stereoscopic image pickup device 3. One of the control signals requests regular-image shooting, and the other thereof requests regular-image data obtained by the regular-image shooting. In this embodiment, upon reception of the control signal requesting the regular-image data, the image pickup device 3 halts the transmission of the preview-image data and commences the transmission of the regular-image data. While the regular-image data is transmitted, the shutter mechanisms 18 and 41 are kept in the closed position.

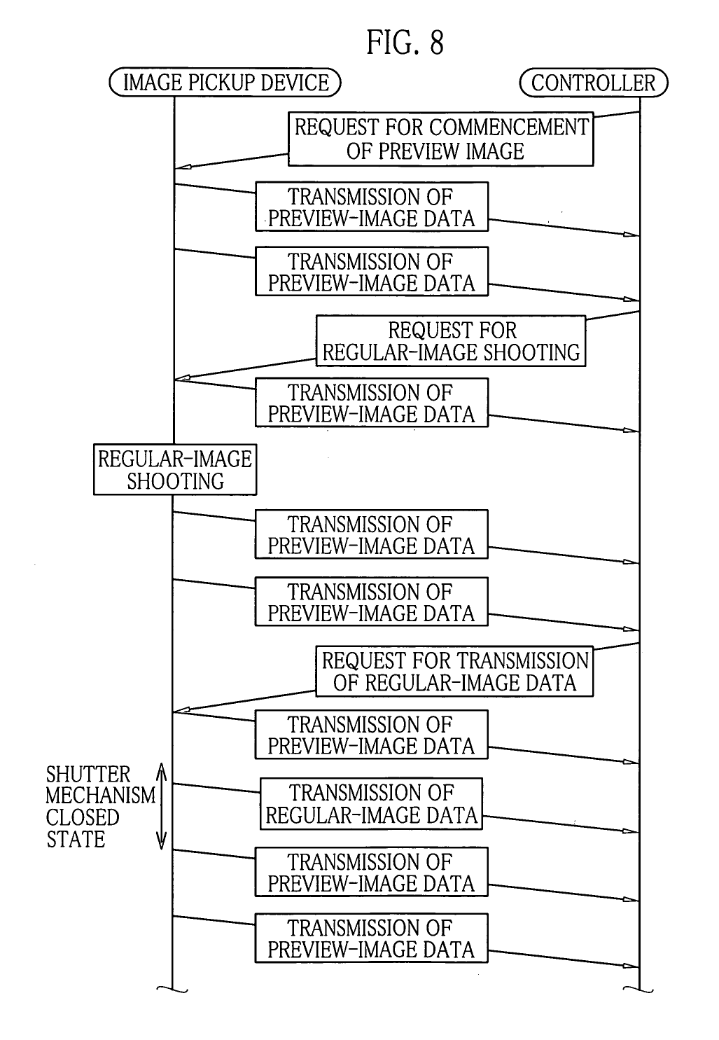

An operation of the above structure is described below with reference to flowcharts shown in FIGS. 8 to 10 and an operational menu picture shown in FIG. 11. Incidentally, attachment of the image pickup device 3 and procedure for activating this device 3 are similar to those of the above first embodiment. The operational menu picture 80 shown in FIG. 11 is displayed on the LCD panel 63 of the controller 4. Within the operational menu picture 80, an image display area 81 and menu buttons 82 to 84 are arranged. The image display area 81 displays the preview image and the regular image. The menu button 82 is pressed to request the commencement of the preview image. The menu button 83 is pressed to request the regular-image shooting. The menu button 84 is pressed to request a taken regular image. A position of the touch screen 65 corresponding to the menu button 82 of the menu picture 80 is pressed to send the control signal, which requests the preview image, to the stereoscopic image pickup device 3 via the communication I/F 67, the communication cable 5 and the communication I/F 48. The CPU 40 having received the control signal activates the first and second imaging units 10 and 11 to perform the preview shooting. At the time of the preview shooting, the first CCD 23 and the second CCD 33 output the image signals of one frame in the intermittent readout pattern. For the image signals, various kinds of signal processing are performed to produce the preview-image data. The produced preview-image data is transmitted to the controller 4 via the communication I/F 48, the communication cable 5 and the communication I/F 67. On the basis of the transmitted preview-image data, the preview image is displayed within the image display area 81 of the LCD panel 63. After that, the succeeding preview-image data is repeatedly produced in the identical sequence and is sent to the controller 4 to display the preview image within the image display area 81 as a through image.

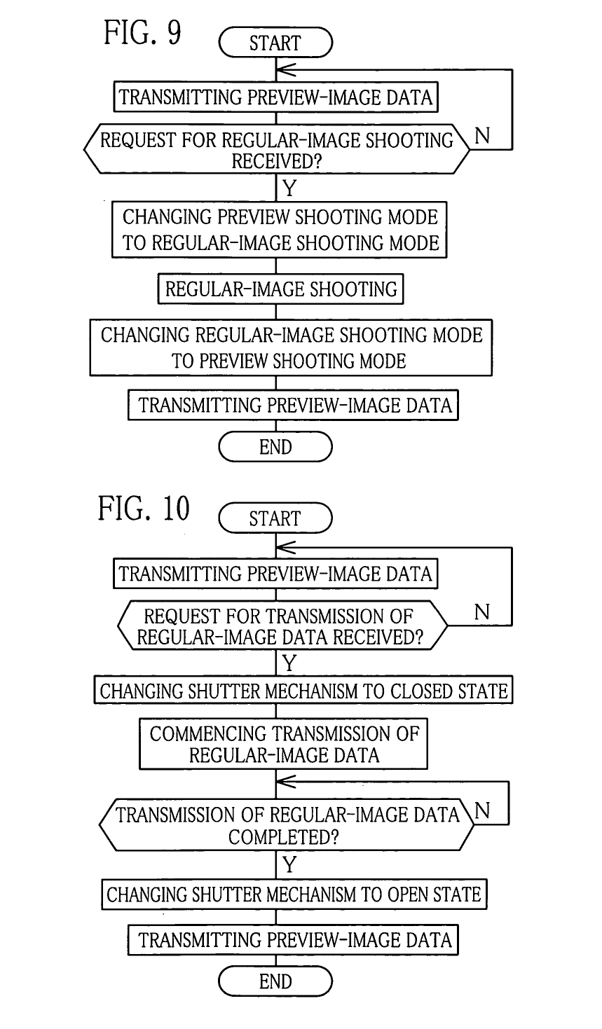

As described above, the preview-image data is normally transmitted to the controller 4 in real time to display the preview image within the image display area 81 of the controller 4 as the through image. When a position of the touch screen 65 corresponding to the menu button 83 has been pressed during the display of the preview image, the control signal for requesting regular-image shooting is sent from the controller 4 to the stereoscopic image pickup device 3 (see FIG. 9).

When the CPU 40 has received the control signal requesting the regular-image shooting, the CPU 40 activates the respective sections of the first and second imaging units 10 and 11 to take a regular image. Further, the CPU 40 outputs the image signal. Incidentally, the transmission of the preview-image data is continued when the CPU 40 receives the control signal requesting the regular-image shooting and while the regular-image shooting is performed. Upon reception of the control signal requesting the regular-image shooting, the shooting mode of the first and second imaging units 10 and 11 is changed from the preview shooting mode to the regular-image shooting mode. At this time, the readout pattern of the CCDs 23 and 33 is changed from the intermittent readout pattern to the all pixel readout pattern. In the changed readout pattern, the image signal is read by one frame. The read image signal is temporarily stored in the system memory 43. After that, various kinds of signal processing are performed to produce the regular-image data. The produced regular-image data is stored in the system memory 43.

After that, when the operation for requesting the transmission of the regular-image data has been performed at the controller 4, namely when a position of the touch screen 65 corresponding to the menu button 84 has been pressed, the control signal requesting the transmission of the regular-image data is sent from the controller 4 to the stereoscopic image pickup device 3 (see FIG. 11). Upon reception of the control signal requesting the transmission of the regular-image data, the CPU 40 reads the regular-image data from the system memory 43 and transmits this data to the controller 4. During the transmission of the regular-image data, the CPU 40 activates the motor drivers 22 and 32 of the first and second imaging units 23 and 33 to set the first and second shutter mechanisms 18 and 41 to the closed position so that the ambient light is prevented from entering the first CCD 23 and the second CCD 33.

On the basis of the regular-image data received by the controller 4, the regular image is displayed within the image display area 81 of the LCD panel 63. At the same time, the regular-image data is recorded in the system memory 62 of the controller 4. After completing the transmission of the regular-image data, the first and second shutter mechanisms 18 and 41 are returned to the open state. Further, the first and second imaging units 10 and 11 are changed to the preview shooting mode to commence the output of the image signal again. The stereoscopic image pickup device 3 is returned to the normal state in that the preview-image data is transmitted, and the preview image is displayed on the controller 4.

In this way, the shutter mechanisms 18 and 41 are kept in the closed state during the transmission of the regular-image data to prevent the ambient light from entering the first CCD 23 and the second CCD 33. Thus, deterioration of the CCD is retarded so that the lifetime of the stereoscopic image pickup device 3 is elongated. While the regular shooting is performed, the preview-image data is simultaneously transmitted. In virtue of this, the preview image is efficiently transmitted.

In the above first and second embodiments, the preview image to be transmitted to the controller 4 is obtained from both of the first CCD 23 and the second CCD 33. The present invention, however, is not limited to this. In a third embodiment of the prevent invention described below, either one of the two imaging units is selected to obtain the preview image. A stereoscopic image pickup system used in the third embodiment has a similar structure with the first embodiment and comprises the stereoscopic image pickup device 3, the controller 4 and the cable 5 for connecting these devices.

In this embodiment, either one of the first and second imaging units 10 and 11 is used for preview shooting. The imaging unit to be used is selected on the basis of an input sent from the controller 4. Although the sole imaging unit is used for taking a preview image, both of the first and second imaging units 10 and 11 are used for taking a regular image.

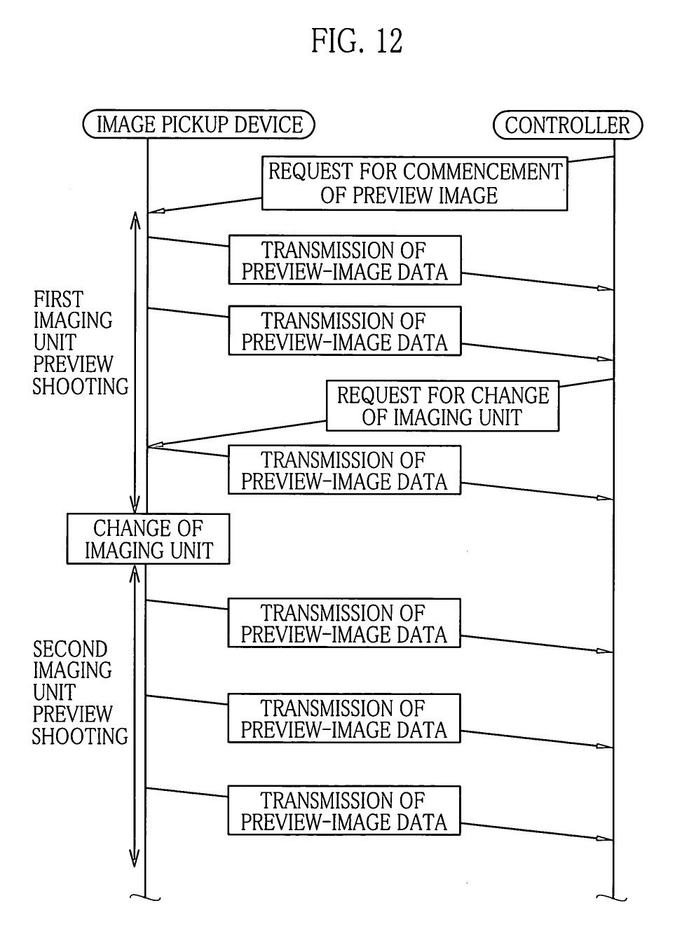

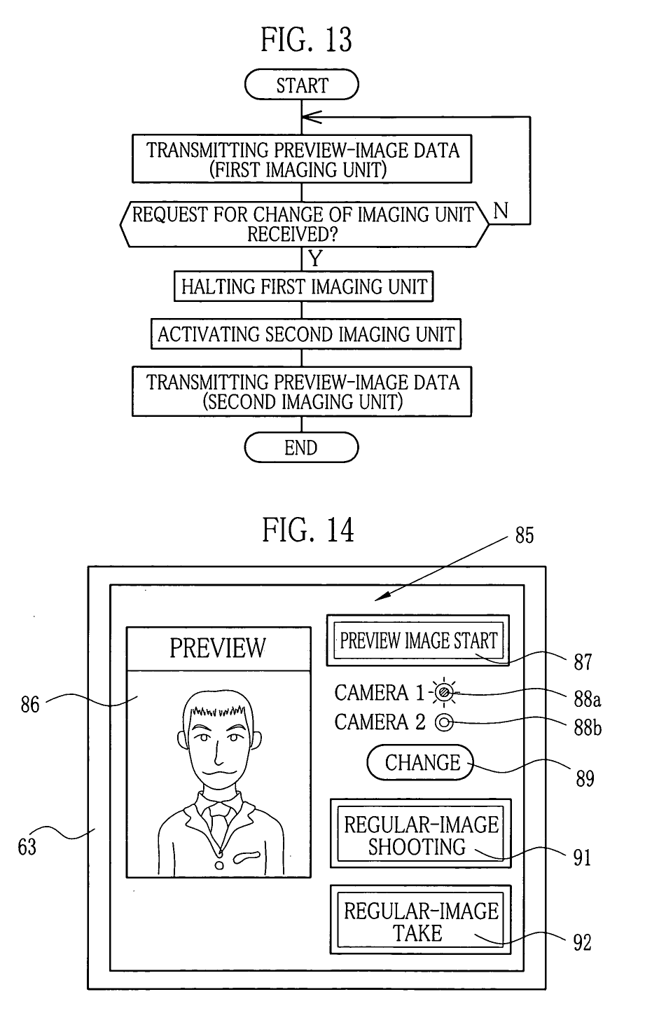

An operation of this embodiment is described below with reference to flowcharts and an operational menu picture shown in FIGS. 12, 13 and 14. Incidentally, attachment of the image pickup device 3 and procedure for activating this device 3 are similar to those of the above first embodiment. The operational menu picture 85 shown in FIG. 14 is displayed on the LCD panel 63 of the controller 4. Within the operational menu picture 85, an image display area 86 and a menu button 87 are arranged. The image display area 86 displays the preview image and the regular image. The menu button 87 is pressed to request the commencement of the preview image. Within the operational menu picture 85, are also arranged indicators 88a and 88b, a change button 89 and menu buttons 91 and 92. The imaging unit to be used for preview shooting is shown by the indicators 88a and 88b, and is changed by the change button 89. The menu button 91 is pressed to request the regular-image shooting. The menu button 92 is pressed to request the taken regular image. A position of the touch screen 65 corresponding to the menu button 87 of the operational menu picture 85 is pressed to send the control signal, which requests the preview image, to the stereoscopic image pickup device 3 via the communication I/F 67, the communication cable 5 and the communication I/F 48. The CPU 40 having received the control signal activates one of the first and second imaging units 10 and 11, which is initially set and is the first imaging unit 10 in this embodiment, to perform the preview shooting. At the time of the preview shooting, the CCD 23 of the first imaging unit 10 is driven in the intermittent readout pattern similar to the first embodiment. Initial setting of the imaging unit to be used for preview shooting is stored in the system memory 43 for example, and is read out at start-up of the stereoscopic image pickup device 3. The CPU 40 performs various kinds of signal processing for the image signal outputted from the first imaging unit 10 to produce the preview-image data. The produced preview-image data is transmitted to the controller 4 via the communication I/F 48, the communication cable 5 and the communication I/F 67. On the basis of the transmitted preview-image data, the preview image is displayed within the image display area 86 of the LCD panel 63. After that, the succeeding preview-image data is repeatedly produced in the identical sequence and is transmitted to the controller 4 to display the preview image within the image display area 86 as a through image.

As described above, the preview-image data is normally transmitted to the controller 4 in real time to display the preview image within the image display area 86 of the controller 4 as the through image. When a position of the touch screen 65 corresponding to the change button 89 has been pressed during the display of the preview image, an instruction for changing the imaging unit performing the preview shooting is inputted. Upon this instruction, a control signal requesting the changeover of the imaging unit is sent from the controller 4 to the stereoscopic image pickup device 3. At this time, lighting display of the indicator is changed from the indicator 88a representing the first imaging unit 10 to the indicator 88b representing the second imaging unit 11.

When the CPU 40 has received the control signal requesting the changeover of the imaging unit, the CPU 40 changes the imaging unit performing the preview shooting. In other words, the first imaging unit 10 used until now is halted, and at the same time, the second imaging unit 11 is activated to commence the preview shooting. And then, the image signal is outputted from the second imaging unit 11 in the intermittent readout pattern to produce the preview-image data. The produced preview-image data is transmitted to the controller 4. On the basis of the transmitted preview-image data, the preview image is displayed within the image display area 86. After that, the succeeding preview-image data is repeatedly produced in the identical sequence and is sent to the controller 4 to display the preview image within the image display area 86 as a through image. Meanwhile, when a position of the touch screen 65 corresponding to the menu button 91 has been pressed, the control signal requesting the regular-image shooting is sent. Upon reception of this control signal, the stereoscopic image pickup device 3 captures the regular-image data similarly to the foregoing first embodiment. Further, when a position of the touch screen 65 corresponding to the menu button 92 has been pressed, the control signal requesting the transmission of the regular-image data is sent. Upon reception of this control signal, the stereoscopic image pick device 3 halts the transmission of the preview-image data and sends the regular-image data. At the same time, the shutter mechanisms 18 and 41 are set to the closed state to prevent the ambient light from entering the imaging areas of the CCDs 23 and 33.

In this way, the sole imaging unit is used while the preview shooting is performed. In addition, the imaging unit performing the preview shooting is changed by the control signal outputted from the controller 4. Thus, deterioration of the CCD is further retarded so that the lifetime of the stereoscopic image pickup device 3 is further elongated.

In the third embodiment, the imaging unit taking the preview image is changed upon the imaging-unit switching operation of the controller 4. The present invention, however, is not limited to this. The imaging unit may be changed upon another operation. In a fourth embodiment of the present invention described below, the imaging unit performing the preview shooting is changed upon an operation of the regular-image shooting. A stereoscopic image pickup system used in the fourth embodiment has a similar structure with the first embodiment and comprises the stereoscopic image pickup device 3, the controller 4 and the cable 5 for connecting these devices.

In this embodiment, either one of the first and second imaging units 10 and 11 performs the preview shooting, and the imaging unit performing the preview shooting is changed upon the operation of the regular-image shooting. Although the sole imaging unit is used for taking a preview image, both of the first and second imaging units 10 and 11 are used for taking a regular image.

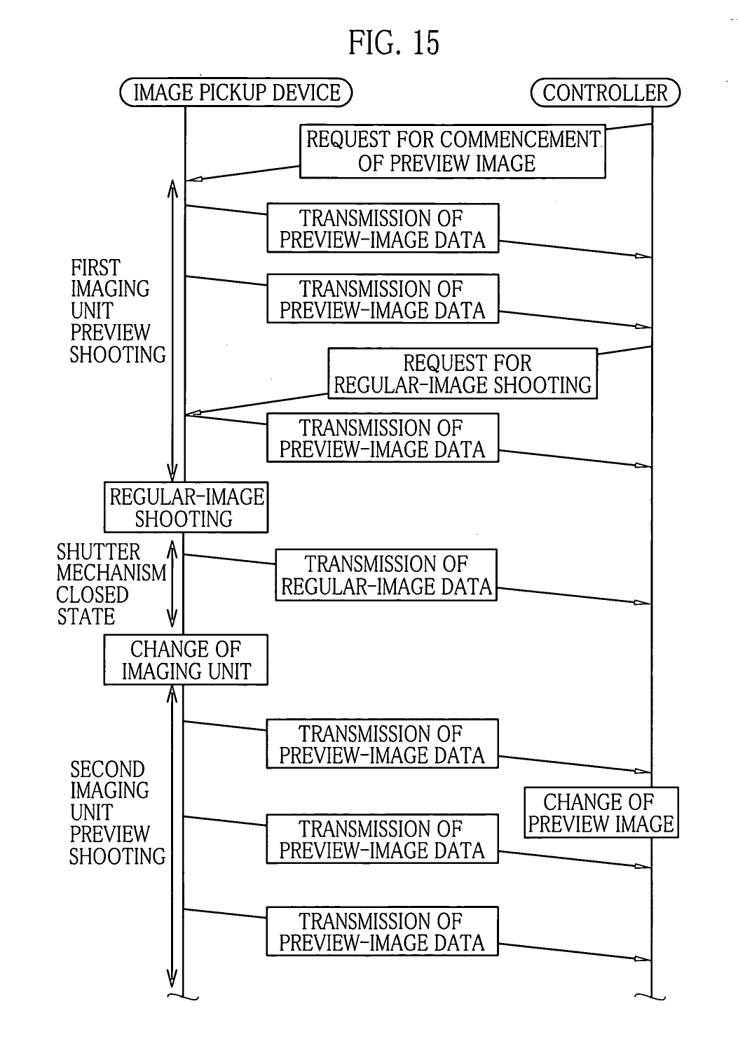

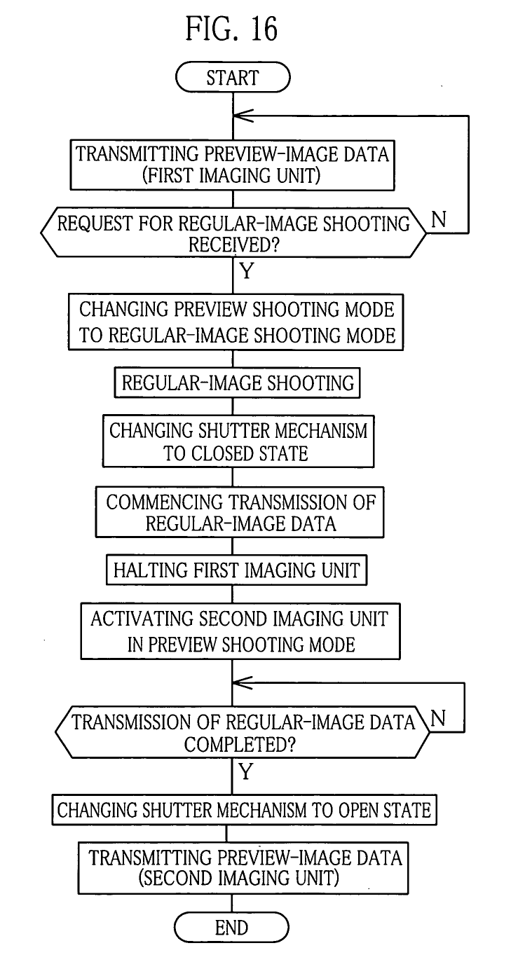

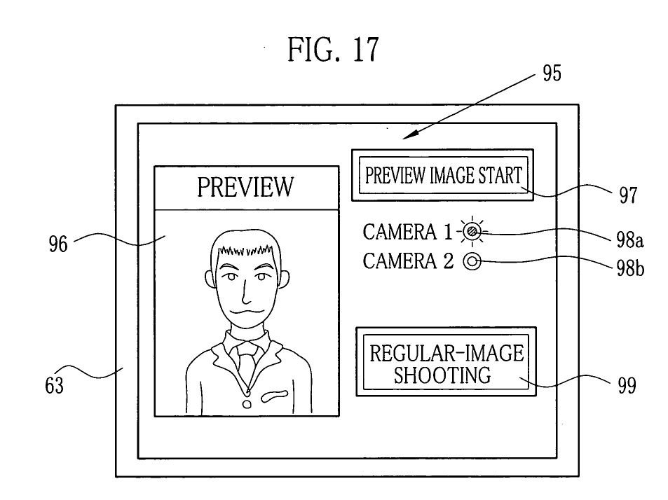

An operation of this embodiment is described below with reference to flowcharts and an operational menu picture shown in FIGS. 15, 16 and 17. Incidentally, attachment of the image pickup device 3 and procedure for activating this device 3 are similar to those of the above first embodiment. The operational menu picture 95 shown in FIG. 17 is displayed on the LCD panel 63 of the controller 4. Within the operational menu picture 95, an image display area 96 and a menu button 97 are arranged. The image display area 96 displays the preview image and the regular image. The menu button 97 is pressed to request the commencement of the preview image. Within the operational menu picture 95, are also arranged indicators 98a, 98b and a menu button 99. The imaging unit to be used for preview shooting is shown by the indicators 98a and 98b. The menu button 99 is pressed to request the regular-image shooting. A position of the touch screen 65 corresponding to the menu button 97 of the operational menu picture 95 is pressed to send the control signal, which requests the preview image, to the stereoscopic image pickup device 3. Upon reception of this control signal, the CPU 40 of the image pickup device 3 activates the first imaging unit 10 to perform the preview shooting. At the time of the preview shooting, the CCD 23 of the first imaging unit 10 is driven in the intermittent readout pattern similarly to the first embodiment. The CPU 40 performs various kinds of signal processing for the image signal outputted from the first imaging unit 10 to produce the preview-image data. The produced preview-image data is transmitted to the controller 4. On the basis of the transmitted preview-image data, the preview image is displayed within the image display area 96 of the LCD panel 63. After that, the succeeding preview-image data is repeatedly produced in the identical sequence and is sent to the controller 4 to display the preview image within the image display area 96 as a through image.

As described above, the preview-image data is normally transmitted to the controller 4 in real time to display the preview image within the image display area 96 of the controller 4 as the through image. When a position of the touch screen 65 corresponding to the menu button 99 of the regular-image shooting has been pressed during the display of the preview image, a control signal requesting the regular-image shooting is sent from the controller 4 to the stereoscopic image pickup device 3. Upon receipt of this control signal, the CPU 40 of the image pickup device 3 controls the respective sections including the first and second imaging units 10 and 11 to produce the regular-image data. Further, the CPU 40 halts the transmission of the preview-image data and sends the regular-image data from the image pickup device 3 to the controller 4. Incidentally, the shutter mechanisms 18 and 41 are kept in the closed state during the transmission of the regular-image data to prevent the ambient light from entering the CCDs 23 and 33.

After commencing the transmission of the regular-image data, the imaging unit performing the preview shooting is changed. In other words, the first imaging unit 10 used until now is halted, and at the same time, the second imaging unit 11 is activated to commence the preview-image shooting. After completing the transmission of the regular-image data, the preview-image data is produced from the image signal outputted from the second imaging unit 11 in the intermittent readout pattern. The produced preview-image data is transmitted to the controller 4. On the basis of the transmitted preview-image data, the preview image is displayed within the image display area 96. At this time, lighting display of the indicator is changed from the indicator 98a representing the first imaging unit 10 to the indicator 98b representing the second imaging unit 11. After that, the succeeding preview-image data is repeatedly produced in the identical sequence and is transmitted to the controller 4 to display the preview image within the image display area 96 as a through image.

Whenever the regular-image data is transmitted, the imaging unit performing the preview-image shooting is changed between the first and second imaging units 11 and 12 in order. In this way, the imaging unit taking the preview image is changed. In virtue of this, deterioration of the CCD is further retarded so that the lifetime of the stereoscopic image pickup device 3 is further elongated. In this embodiment, since the imaging unit is changed upon the operation of the regular-image shooting, it is unnecessary to perform an exclusive operation for changing the imaging unit.

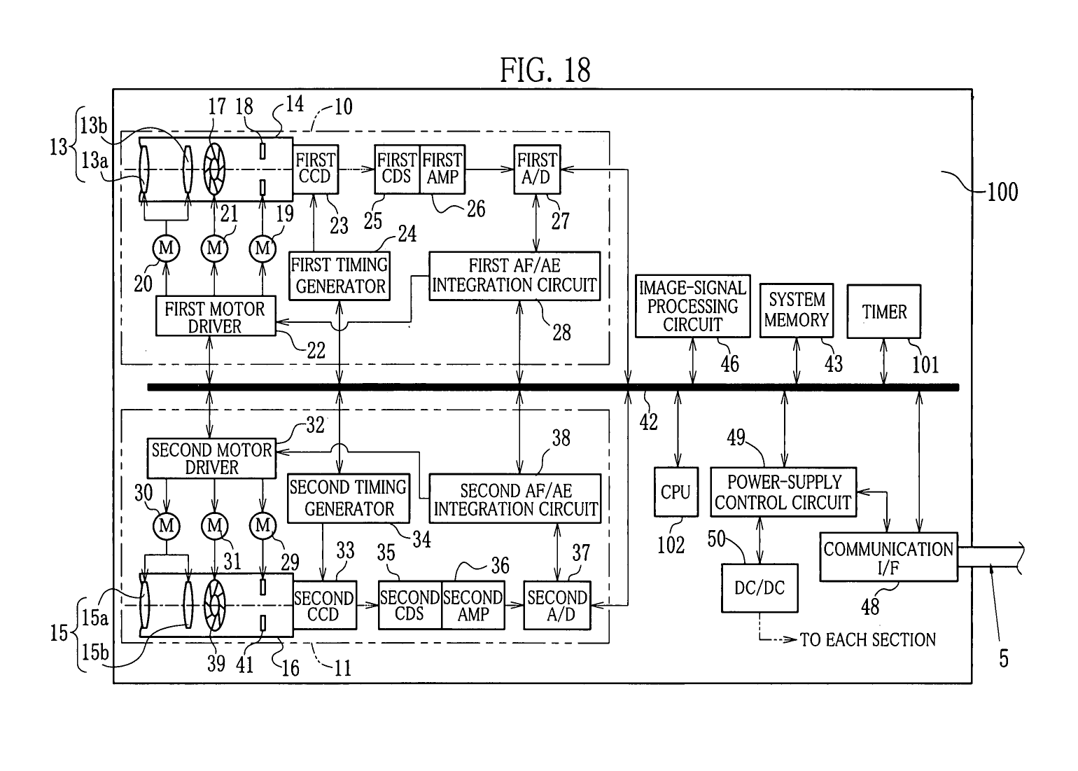

In the above third and fourth embodiments, the imaging unit performing the preview shooting is changed upon reception of the control signal outputted from the controller 4 and upon transmission of the regular-image data. The present invention, however, is not limited to these. The imaging unit may be changed every predetermined period. In a fifth embodiment of the present invention described below, the imaging unit is changed every predetermined period to take the preview image. A stereoscopic image pickup device 100 according to the fifth embodiment has a structure shown in FIG. 18. Similarly to the above embodiments, the image pickup device 100 is connected to the controller (external control device) 4 via the communication cable 5.

The stereoscopic image pickup device 100 comprises the first and second imaging units 10 and 11 similarly to the first embodiment, and further comprises a timer 101 and a CPU 102 for controlling each section of the image pickup device 100. A component identical with that of the first embodiment is denoted by the same reference numeral and description thereof is abbreviated.

The timer 101 is connected to the CPU 102 via the data bus 42 and counts elapsed time from the commencement of the preview-image shooting. In this embodiment, the system memory 43 stores a changeover time for changing the imaging unit.

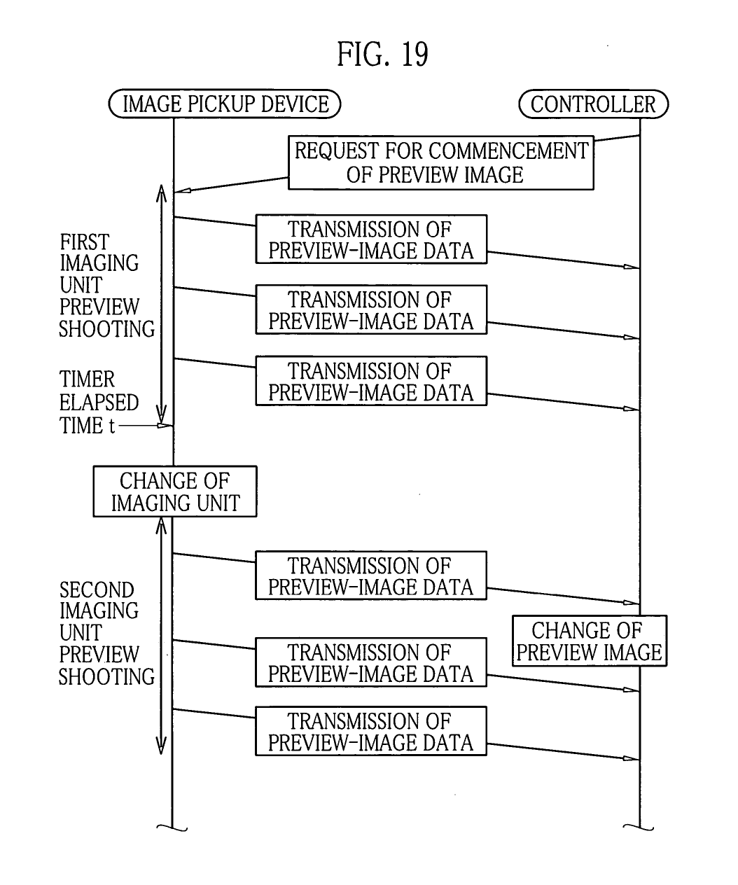

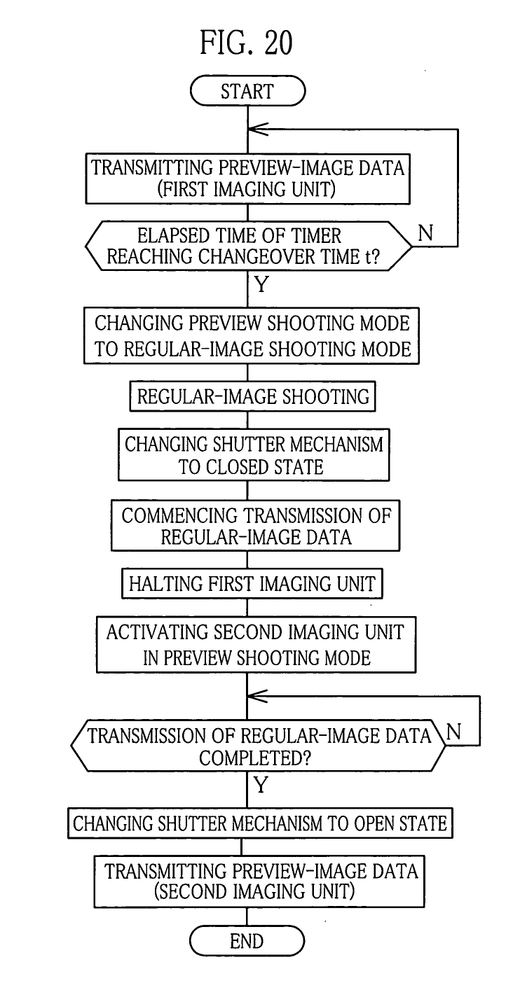

Next, an operation of the above-mentioned structure is described below with reference to flowcharts shown in FIGS. 19 and 20. Incidentally, attachment of the image pickup device 100 and procedure for activating this device 100 are similar to those of the foregoing first embodiment. Moreover, an operational menu picture displayed on the controller 4 at this time is identical with the operational menu picture 95 (see FIG. 17) described in the fourth embodiment. The touch screen 65 is pressed to send the control signal, which requests the preview image, to the image pickup device 100. Upon reception of this control signal, the CPU 102 of the image pickup device 100 activates the first imaging unit 10 to perform the preview-image shooting. At the time of the preview-image shooting, the CCD 23 of the first imaging unit 10 is driven in the intermittent readout pattern similarly to the first embodiment. The CPU 102 performs various kinds of signal processing for the image signal outputted from the first imaging unit 10 to produce the preview-image data. The produced preview-image data is transmitted to the controller 4. On the basis of the transmitted preview-image data, the preview image is displayed on the LCD panel 63. After that, the succeeding preview-image data is repeatedly produced in the identical sequence and is transmitted to the controller 4 to display the preview image on the LCD panel 63 as a through image.

In this way, the preview-image data is normally transmitted to the controller 4 in real time to display the preview image on the controller 4 as the through image. At the start time of the transmission of the preview-image data, the changeover time for changing the imaging unit is read from the system memory 43, and simultaneously the timer 101 of the imaging pickup device 3 commences counting the elapsed time. When the elapsed time counted by the timer 101 has reached the changeover time t, the imaging unit performing the preview-image shooting is changed. In other words, the first imaging unit 10 used until now is halted, and at the same time, the second imaging unit 11 is activated to commence the preview shooting. And then, the image signal is outputted from the second imaging unit 11 in the intermittent readout pattern to produce the preview-image data. The produced preview-image data is transmitted to the controller 4. On the basis of the transmitted preview-image data, the preview image is displayed on the controller 4. After that, the succeeding preview-image data is repeatedly produced in the identical sequence and is transmitted to the controller 4 to display the preview image on the LCD 63 as a through image.

Whenever the predetermined changeover time t has passed, the imaging unit performing the preview-image shooting is changed between the first and second imaging units 11 and 12 in order. In this way, the imaging unit taking the preview image is changed. In virtue of this, deterioration of the CCD is further retarded so that the lifetime of the stereoscopic image pickup device 3 is further elongated. In this embodiment, since the imaging unit is changed every predetermined time, it is unnecessary to perform an exclusive operation for changing the imaging unit.

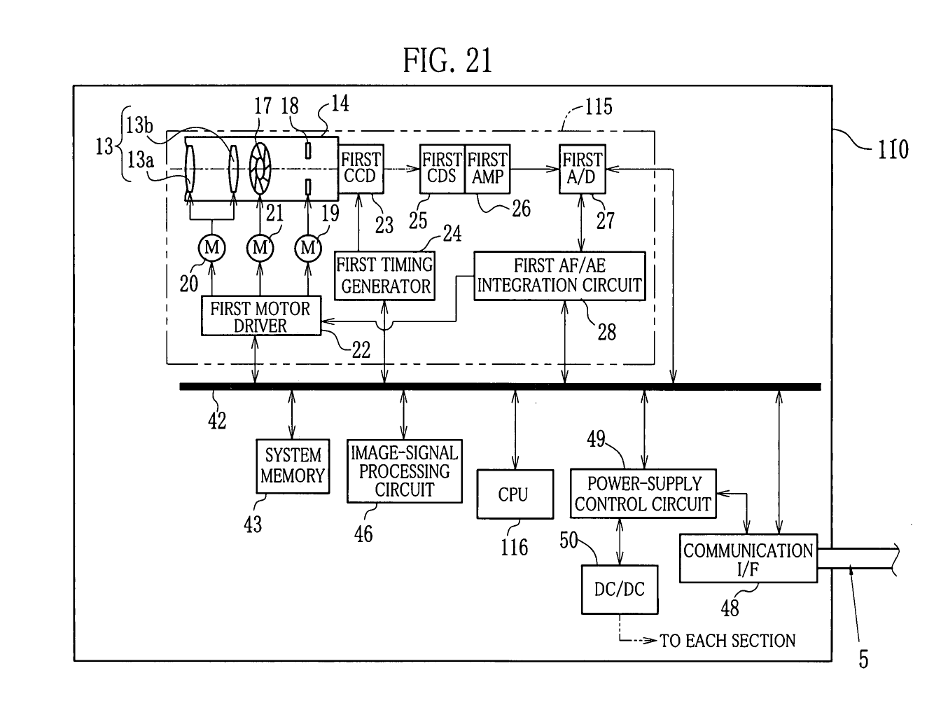

In the above-described first through fifth embodiments, the image pickup device comprises the plural imaging units from which the preview image and the regular image are obtained. The present invention, however, is not limited to this and may be adopted to an image pickup device having a single imaging unit. In a sixth embodiment of the present invention described below, an image pickup device employs the sole imaging unit. The image pickup device 110 of this embodiment has a structure shown in FIG. 21. Similarly to the first embodiment, the image pickup device 110 is connected to the controller (external control device) 4 via the communication cable 5.

The image pickup device 110 includes the sole imaging unit 115 and a CPU 116 for controlling each section of the image pickup device 110. A component identical with that of the first embodiment is denoted by the same reference numeral and description thereof is abbreviated.

When the image pickup device 110 having the above structure is used as a monitoring camera, an authentication camera and so forth, the preview image and the regular image are obtained from image signals outputted from the CCD 23 of the imaging unit 115. The obtained image is sent to the controller 4. Sequence executed at this time is identical with that of the first embodiment. While the image pickup device 110 transmits the regular-image data, the transmission of the preview-image data is halted and the shutter mechanism 18 is kept in the closed state. In virtue of this, the deterioration of the CCD is retarded so that the lifetime of the image pickup device 110 is elongated.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. An image pickup device connected to an external control device via a communication tool, said image pickup device operating in response to various control signals sent from said external control device, said image pickup device comprising:
an optical system including a shutter mechanism;
an image sensor disposed behind said optical system;
a signal processor for processing an image signal outputted from said image sensor, said signal processor producing preview-image data and regular-image data on the basis of said image signal;
a communication processor for performing transmission and reception with said external control device via said communication tool; and
a controller for controlling said communication processor to transmit said preview-image data to said external control device in real time, said controller halting transmission of said preview-image data and transmitting said regular-image data to said external control device upon reception of said control signal which is sent from said external control device to request regular-image shooting,
wherein said shutter mechanism is kept in a closed state to prevent ambient light from entering said image sensor while said regular-image data is transmitted.

2. The image pickup device according to claim 1, further comprising:
a motor connected to said shutter mechanism, said controller actuating said motor to set said shutter mechanism to said closed state.

3. The image pickup device according to claim 1, wherein said preview-image data is produced after thinning said image signal outputted from said image sensor.

4. The image pickup device according to claim 3, wherein said regular-image data is produced from said image signal of all pixels outputted from said image sensor.

5. The image pickup device according to claim 1, wherein said image sensor is a CCD.

6. A multi-eye image pickup device connected to an external control device via a communication tool, said multi-eye image pickup device operating in response to various control signals sent from said external control device, said multi-eye image pickup device comprising:
a plurality of imaging units respectively having an optical system, in which a shutter mechanism is included, and an image sensor disposed behind said optical system;
a signal processor for processing image signal outputted from said image sensor, said signal processor producing preview-image data and regular-image data on the basis of said image signal;
a communication processor for performing transmission and reception with said external control device via said communication tool; and
a controller for controlling said communication processor to transmit said preview-image data to said external control device in real time, said controller halting transmission of said preview-image data and transmitting said regular-image data to said external control device upon reception of said control signal which is sent from said external control device to request regular-image shooting,
wherein said shutter mechanism is kept in a closed state to prevent ambient light from entering said image sensor while said regular-image data is transmitted.

7. The multi-eye image pickup device according to claim 6, wherein one of said imaging units is selected and said preview-image data is produced from said image signal outputted from the selected imaging unit.

8. The multi-eye image pickup device according to claim 7, wherein one of said imaging units is selected so as to be changed every predetermined period.

9. The multi-eye image pickup device according to claim 7, wherein one of said imaging units is selected so as to be changed after transmitting said regular-image data.

10. The multi-eye image pickup device according to claim 6, further comprising:
a motor connected to said shutter mechanism, said controller actuating said motor to set said shutter mechanism to said closed state.

11. The multi-eye image pickup device according to claim 6, wherein said preview-image data is produced after thinning said image signal outputted from said image sensor.

12. The multi-eye image pickup device according to claim 11, wherein said regular-image data is produced from said image signal of all pixels outputted from said image sensor.

13. The multi-eye image pickup device according to claim 6, wherein said image sensor is a CCD.

14. A control program for a multi-eye image pickup device connected to an external control device via a communication tool, said multi-eye image pickup device comprising a plurality of imaging units respectively having an optical system, in which a shutter mechanism is included, and an image sensor disposed behind said optical system, said control program making said multi-eye image pickup device execute the steps of:
transmitting preview-image data, which is produced on the basis of an image signal outputted from said imaging unit, to said external control device in real time;
producing regular-image data on the basis of said image signal upon reception of a control signal which is sent from said external control device to request regular-image shooting;
halting transmission of said preview-image data after producing said regular-image data to transmit said regular-image data to said external control device; and
keeping said shutter mechanism in a closed state to prevent ambient light from entering said image sensor while said regular-image data is transmitted.

15. The control program according to claim 14, further making said multi-eye image pickup device execute the step of:
selecting one of said imaging units, said preview-image data being produced from said image signal outputted from the selected imaging unit.

16. The control program according to claim 15, further making said multi-eye image pickup device execute the step of:
changing the selected imaging unit every predetermined period.

17. The control program according to claim 15, further making said multi-eye image pickup device execute the step of:
changing the selected imaging unit in association with the transmission of said regular-image data.

18. The control program according to claim 14, wherein said preview-image data is produced after thinning said image signal outputted from said image sensor.

19. The control program according to claim 18, wherein said regular-image data is produced from said image signal of all pixels outputted from said image sensor.

20. The control program according to claim 14, wherein said image sensor is a CCD.
